(19) United States
(12) Patent Application Publication
(10) Pub. No.: US 2025/0245796 A1
(43) Pub. Date: Jul. 31, 2025

(54) GENERATION OF SYNTHETIC DATA FOR IMAGE REGISTRATION TRAINING

(71) Applicant: Samsung Electronics Co., Ltd., Suwon-si (KR)

(72) Inventors: Joshua D. Rego, Mesa, AZ (US); Zeeshan Nadir, Allen, TX (US); Pavan Madhusudanarao, Plano, TX (US); Hamid R. Sheikh, Allen, TX (US)

(21) Appl. No.: 18/426,025

(22) Filed: Jan. 29, 2024

(51) Int. Cl. G06T 5/90; G06T 3/18; G06T 7/11; G06T 7/20; G06T 7/30; G06T 7/50; G06V 10/26; G06V 10/44

(52) U.S. Cl. CPC G06T 5/90; G06T 3/18; G06T 7/11; G06T 7/20; G06T 7/30; G06T 7/50; G06V 10/26; G06V 10/44

(57) ABSTRACT

A method includes generating, using at least one processing device, a ground truth optical flow map for displacement of pixels within a reference image based on a motion model. The motion model determines 3D coordinates of pixels within the reference image based on estimated depths of the pixels within the reference image. The method also includes performing, using the at least one processing device, 3D to 2D reprojection of the pixels within the reference image based on the motion model to generate a reprojected image view corresponding to a shifted camera perspective. The method further includes generating, using the at least one processing device, an occlusion mask for the reference image. The occlusion mask corresponds to occluded pixels within the reprojected image view. In addition, the method includes performing, using the at least one processing device, occlusion region inpainting of the occluded pixels to generate an inpainted reprojected image view.

### TECHNICAL FIELD

This disclosure relates generally to machine learning systems and processes. More specifically, this disclosure relates to generation of synthetic data for image registration training.

### BACKGROUND

The development of machine learning algorithms (including deep neural networks) has positively impacted almost all fields relating to technology, including smartphone cameras or other portable device cameras. Machine learning models can consume tremendous quantities of data, and ever-greater amounts of labeled high-quality training data for machine learning models is often needed in order produce superior results. However, manually acquiring adequate amounts of labeled ground truth data at scale is almost impossible for a variety of reasons. The labeled ground truth data can include information at the individual pixel level, such as depth maps and segmentation masks, which provides a great deal of information about the dataset.

### SUMMARY

This disclosure relates to generation of synthetic data for image registration training.

In a first embodiment, an electronic device includes at least one memory configured to store a motion model for determining three-dimensional (3D) coordinates of pixels within a reference image based on estimated depths of the pixels within the reference image. The electronic device also includes at least one processing device configured to generate a ground truth optical flow map for displacement of the pixels within the reference image based on the motion model. The at least one processing device is also configured to perform 3D to two-dimensional (2D) reprojection of the pixels within the reference image based on the motion model to generate a reprojected image view corresponding to a shifted camera perspective. The at least one processing device is further configured to generate an occlusion mask for the reference image, where the occlusion mask corresponds to occluded pixels within the reprojected image view. In addition, the at least one processing device is configured to perform occlusion region inpainting of the occluded pixels to generate an inpainted reprojected image view. In other embodiments, a non-transitory machine readable medium includes instructions that when executed cause at least one processor of an electronic device to perform these functions.

In a second embodiment, a method includes generating, using at least one processing device of an electronic device, a ground truth optical flow map for displacement of pixels within a reference image based on a motion model, where the motion model determines 3D coordinates of pixels within the reference image based on estimated depths of the pixels within the reference image. The method also includes performing, using the at least one processing device, 3D to 2D reprojection of the pixels within the reference image based on the motion model to generate a reprojected image view corresponding to a shifted camera perspective. The method further includes generating, using the at least one processing device, an occlusion mask for the reference image, where the occlusion mask corresponds to occluded pixels within the reprojected image view. In addition, the method includes performing, using the at least one processing device, occlusion region inpainting of the occluded pixels to generate an inpainted reprojected image view.

In a third embodiment, an electronic device at least one memory configured to store a first image registration model and a second image registration model each trained using synthetic data. The at least one memory is also configured to store first and second images, where the first image corresponds to a scene from a first camera perspective the second image corresponds to the scene from a second camera perspective. The electronic device also includes at least one processing device configured to analyze motion between the first camera perspective and the second camera perspective. The at least one processing device is also configured, based on the analyzed motion, to select one of the first image registration model and the second image registration model to perform registration of the first image and the second image. In other embodiments, a non-transitory machine readable medium includes instructions that when executed cause at least one processor of an electronic device to perform these functions. In still other embodiments, a method includes performance of these functions.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIGS. 2 and 2A collectively illustrate an example process of training a registration model using synthetic camera motion data and a method for synthetic data generation in accordance with this disclosure;

FIG. 3 illustrates example operation of a depth estimation function used during generation of a ground truth flow map as described in connection with FIGS. 2 and 2A in accordance with this disclosure;

FIGS. 4A through 4C illustrate example camera rotations supported by a motion model during generation of a ground truth flow map as described in connection with FIGS. 2 and 2A in accordance with this disclosure;

FIG. 5 illustrates example operation of a 3D to 2D reprojection function used during generation of a ground truth flow map as described in connection with FIGS. 2 and 2A in accordance with this disclosure;

FIGS. 6A through 6F illustrate example computation of a ground truth flow map as described in connection with FIGS. 2 and 2A in accordance with this disclosure;

FIGS. 7A through 7C graphically illustrate an example determination of an occlusion mask and subsequent inpainting for use with a ground truth flow map as described in connection with FIGS. 2 and 2A in accordance with this disclosure;

FIGS. 8 and 9 comparatively illustrate a non-AI method of image registration with use of inferences on a registration model trained on synthetic data in accordance with this disclosure;

FIG. 10 illustrates an example system using multiple registration models trained on synthetic data in accordance with this disclosure;

FIG. 11 illustrates an example motion scale analysis function as described in connection with FIG. 10 in accordance with this disclosure;

FIG. 12 illustrates an example system utilizing image patch division or segmentation in conjunction with a registration model trained on synthetic data in accordance with this disclosure;

FIG. 13 illustrates an example process for generation of synthetic data with additional view occlusion mask determination for training a registration model in accordance with this disclosure;

FIG. 14 illustrates an example process for training an image registration model on synthetic data in accordance with this disclosure; and

FIGS. 15A and 15B and FIGS. 16A and 16B illustrate examples of artifacts due to image registration errors.

### DETAILED DESCRIPTION

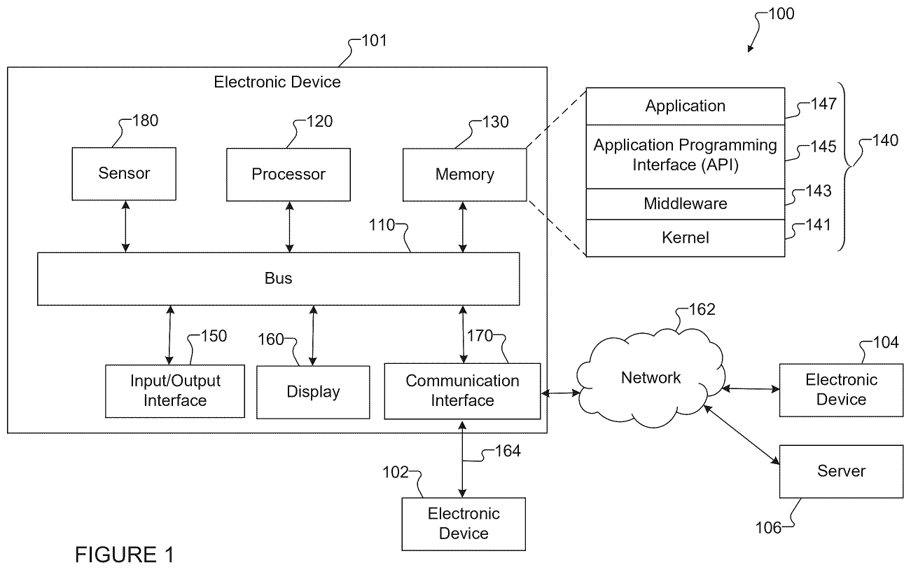

FIGS. 1 through 16B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, the development of machine learning algorithms (including deep neural networks) has positively impacted almost all fields relating to technology, including smartphone cameras or other portable device cameras. Machine learning models can consume tremendous quantities of data, and ever-greater amounts of labeled high-quality training data for machine learning models is often needed in order produce superior results. However, manually acquiring adequate amounts of labeled ground truth data at scale is almost impossible for a variety of reasons. The labeled ground truth data can include information at the individual pixel level, such as depth maps and segmentation masks, which provides a great deal of information about the dataset.

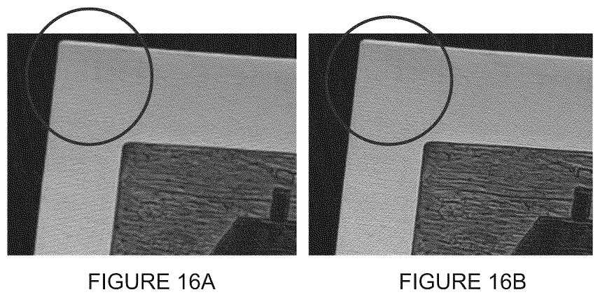

FIGS. 15A and 15B and FIGS. 16A and 16B are examples of artifacts due to image registration errors. In FIG. 15A, a thin line indicated by arrows is an artifact due to registration error(s) that should not be present as shown in FIG. 15B (arrows retained for reference). Similarly, texture irregularities in the circled region of FIG. 16A indicates failed registration, while the regular texture at the same region of FIG. 16B reflects successful registration.

The need for ground truth data to improve image registration has led to the rise in demand for synthetic training data. Specifically, for image registration (often a key component in camera image processing pipelines), unsupervised or self-supervised training methods have been attempted, but most state-of-the-art networks are trained in a fully-supervised setting.

To train deep neural networks or other machine learning models for image registration, popular synthetic datasets include “Flying Chairs” (which includes image pairs and corresponding flow fields for purely planar motion), the Karlsruhe Institute of Technology and Toyota Technological Institute (KITTI) Vision Benchmark Suite, and the Max Planck Institute (MPI) open source 3D animated short film Sintel. However, registration by deep neural networks trained on these image datasets is not satisfactory.

This disclosure provides various techniques for generating real synthetically-labelled ground truth datasets for training image registration models. The techniques described here make use of existing real data captures, such as when both mono and stereo image captures may be used. Image registration models trained on the resulting data produce better image registration outputs in comparison with existing datasets or technologies. In some embodiments, a synthetic data pipeline to create training data is used to train a model for image registration tasks in a fully-supervised setting. Existing real data captures can be used to generate synthetic motion data by estimating a depth map using a single real image or an image pair and using the depth information to re-project a reference image. A camera projection model can be used to re-project another view of the same image along with inpainting. A corresponding pixel displacement map can also be produced using the ground truth depth map. The pipeline thus produces a pair of images along with a ground truth displacement/optical flow map between the images.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for generating and/or using one or more synthetically-labelled ground truth datasets for training image registration.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for generating and/or using one or more synthetically-labelled ground truth datasets for training image registration. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, as well as executing the function or service on its own, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations for generating and/or using one or more synthetically-labelled ground truth datasets for training image registration.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

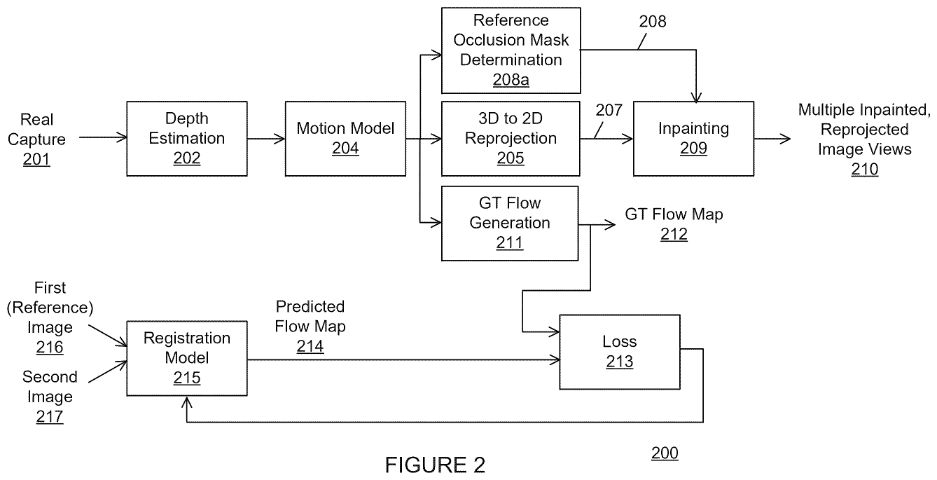

FIGS. 2 and 2A collectively illustrate an example process 200 of training a registration model using synthetic camera motion data and a method for synthetic data generation in accordance with this disclosure. For ease of explanation, the process 200 shown in FIG. 2 is described as being implemented using one or more components of the network configuration 100 of FIG. 1 described above, such as one or more servers 106. However, this is merely one example, and the process 200 could be implemented using any other suitable device(s) and in any other suitable system(s), such as when the process 200 is performed using an electronic device 101.

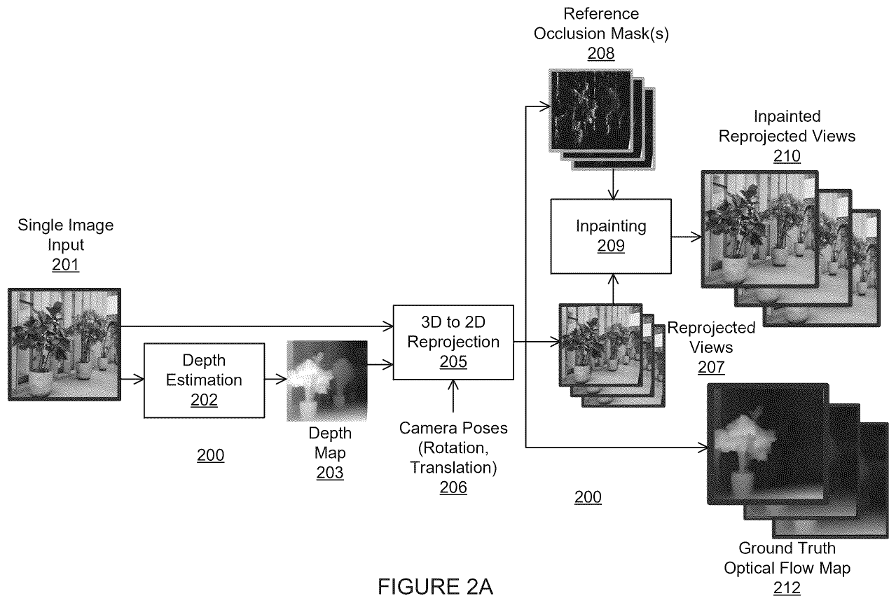

As shown in FIGS. 2 and 2A, for process 200 of a registration model, a real captured image 201 (also called a “reference” image) is employed as input. The captured image 201 may be acquired in any suitable manner and from any suitable source, such as by using one or more imaging sensors 180. A depth estimation function 202 is performed using the captured image 201 in order to generate a depth map 203, which identifies depths of different areas within the scene in the captured image 201. For example, the depth map 203 may have the same resolution as the captured image 201, and each pixel of the depth map 203 may identify a depth of an associated pixel in the captured image 201. The depth estimation function 202 may use any suitable technique for identifying depths within captured images. One example of the operation of the depth estimation function 202 is described in greater detail below in connection with FIG. 3.

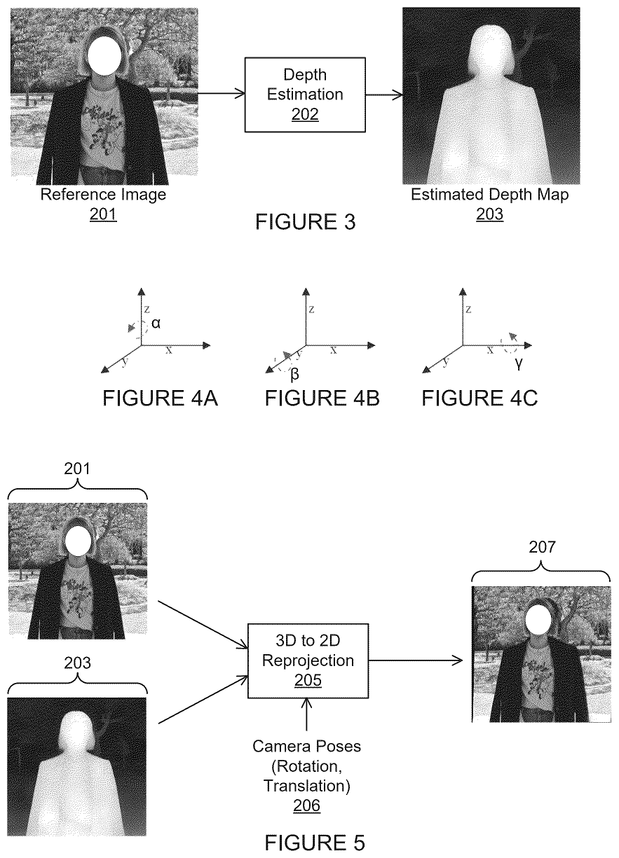

A motion model 204 is used to process the estimated depths within the captured image 201 in order to help project pixels for different objects within the captured image 201 onto a three-dimensional (3D) coordinate system. The motion model 204 can thereby generate 3D information corresponding to the captured image 201 by taking into account the camera motion to generate a second view or a third view. For example, the motion model 204 can determine 3D coordinates of pixels within the captured image 201 based on estimated depths of the pixels within the captured image 201. Examples of camera rotations supported by the motion model 204 are described in greater detail below in connection with FIGS. 4A through 4C, where different coordinate rotations are shown modelling the phenomenon of camera rotations. Furthermore, the motion model can also include camera translation motions.

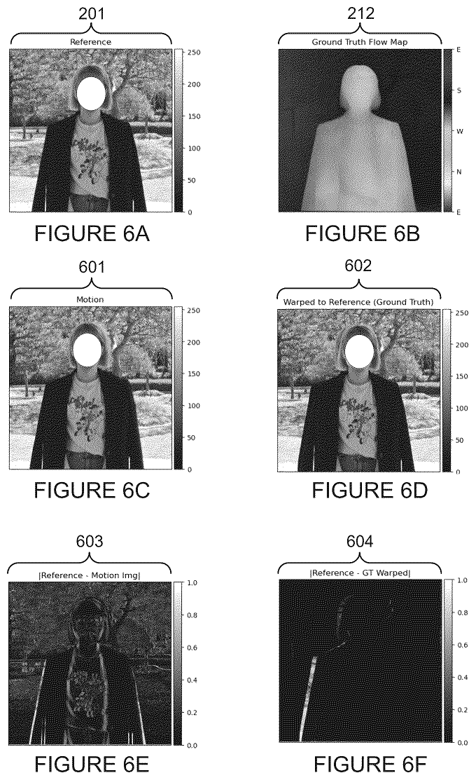

Camera poses 206 represent different poses of the imaging device, such as the pose used to obtain the captured image 201 and at least one other pose. For example, a rotation and/or a translation of camera perspective can be shifted from one camera pose 206 to define another camera pose 206. This allows the camera poses 206 to define different camera perspectives of the same scene, which can allow synthetic images to be generated of the scene from different camera perspectives or synthetic views. For instance, the camera poses 206 can be used by a 3D to two-dimensional (2D) reprojection function 205 to project objects (pixels) within a synthetic view defined by a camera pose 206 onto a single image plane to form a reprojected view 207. The 3D to 2D reprojection function 205 may use any suitable technique to project image data. In some embodiments, the 3D to 2D reprojection function 205 may be performed for multiple shifts in camera perspective (multiple camera poses) in order to produce multiple reprojected views 207. That is, the 3D to 2D reprojection function 205 may be performed repeatedly to generate multiple reprojected views 207 of the same scene from different camera perspectives. One example of the operation of the 3D to 2D reprojection function 205 is described in greater detail below in connection with FIG. 5.

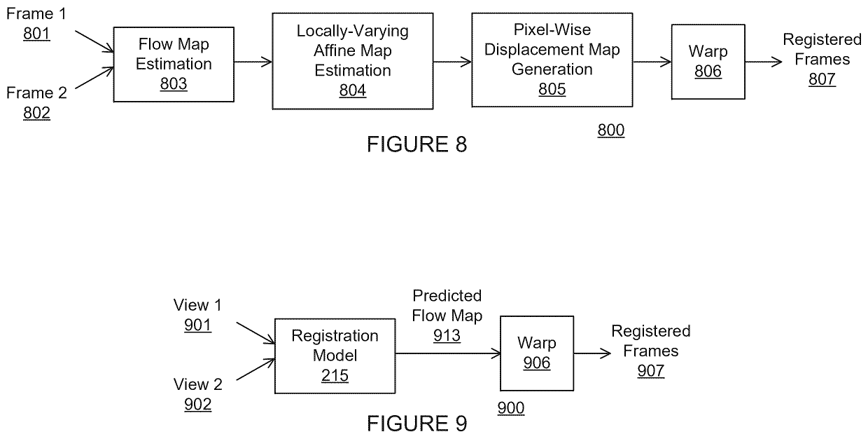

One or more reference occlusion masks 208 are generated based on the reprojected view(s) 207 determined according to the motion model 204. Each reference occlusion mask 208 identifies where a reprojected view 207 may lack image content, such as due to occlusion of one object by another object within the scene. Each reference occlusion mask 208 can be generated in any suitable manner. Using the reference occlusion mask(s) 208, an inpainting function 209 can be performed on the reprojected view(s) 207 to produce one or more inpainted reprojected image views 210. The inpainting function 209 attempts to use contents of each reprojected view 207 (or other reprojected view(s)) in order to fill in missing image content in the occluded area(s) within that reprojected view 207. Ideally, each inpainted reprojected image view 210 represents a complete view of a scene as captured from a specified camera perspective. The inpainting function 209 may use any suitable technique to perform image inpainting. Example operations that may be performed by the inpainting function 209 are described in greater detail below in connection with FIGS. 7A through 7C.

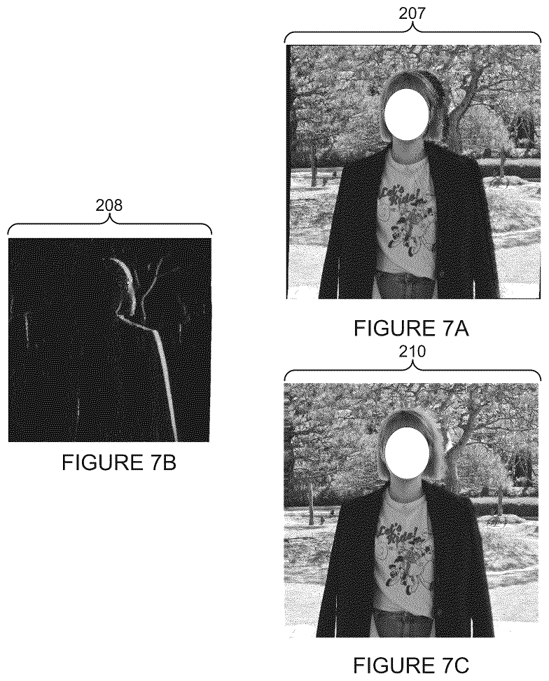

The 3D information for the captured image 201 that is generated using the motion model 204 is also provided to a ground truth (GT) flow generation function 211, which generates ground truth flow maps 212. Each ground truth flow map 212 identifies the optical flow, such as the movement of the pixels, between multiple images. For example, the ground truth flow maps 212 can identify the optical flows between different reprojected image views 210. The ground truth flow generation function 211 may use any suitable technique to generate ground truth flow maps. Example operations that may be performed by the ground truth flow generation function 211 are described in greater detail below in connection with FIGS. 6A through 6F.

The ground truth flow maps 212 generated by the ground truth flow generation function 211 are provided to a loss function 213. The loss function 213 also receives one or more predicted flow maps 214 generated during training of a registration model 215. The registration model 215 represents a machine learning model that is trained or being trained to align or register images. The registration model 215 may include any suitable machine learning model, such as a deep neural network (DNN) or other neural network. During training, the registration model 215 operates on a first (reference) image 216 of a scene and a second image 217 of the same scene, typically with at least a somewhat different camera perspective. For example, each first image 216 may be a captured image 201, and each second image may be an inpainted reprojected view 210 generated using that captured image 201. The loss function 213 compares each predicted flow map 214 from the registration model 215 with the corresponding ground truth flow map 212 to identify differences or errors between the two, and the errors are used to calculate a loss of the registration model 215. If needed (such as when the loss exceeds a threshold), weights or other parameters of the registration model 215 can be adjusted to try and reduce or minimize the errors. Training of the registration model 215 can continue in this manner until the loss becomes ideally low (such as by falling below the threshold).

Although FIGS. 2 and 2A collectively illustrate one example of the process 200 of a registration model 215 using synthetic camera motion data, various changes may be made to FIGS. 2 and 2A. For example, various components and functions in FIGS. 2 and 2A may be combined, further subdivided, replicated, rearranged, or omitted according to particular needs. Also, one or more additional components and functions may be included in FIGS. 2 and 2A if needed or desired.

FIG. 3 illustrates example operation of the depth estimation function 202 used during generation of a ground truth flow map as described in connection with FIGS. 2 and 2A in accordance with this disclosure. As shown in FIG. 3, an example reference image 201 is shown, where the reference image 201 represents an image of a person (whose face has been obscured for privacy). The reference image 201 is processed by the depth estimation function 202 to generate a depth map 203. The depth map 203 uses different values to identify depths within the scene captured by the reference image 201. For example, brighter image values in the depth map 203 may indicate smaller depths within the scene, and darker image values in the depth map 203 may indicate larger depths within the scene.

The depth estimation function 202 may use any suitable technique for identifying depths within captured images. In some embodiments, for example, the depth estimation function 202 may determine depths using the techniques described in Miangoleh et al, “Boosting Monocular Depth Estimation Models to High-Resolution via Content-Adaptive Multi-Resolution Merging,” 2021 IEEE/CVF Conference on Computer Vision and Pattern Recognition (CVPR), June 2021 or Ranftl et al, “Towards Robust Monocular Depth Estimation: Mixing Datasets for Zero-shot Cross-dataset Transfer,” IEEE Transactions on Pattern Analysis and Machine Intelligence, Volume 44, Issue 3, March 2022 (both of which are hereby incorporated by reference in their entirety). However, this disclosure is not limited to any specific technique for generating depth maps.

Although FIG. 3 illustrates one example operation of the depth estimation function 202 used during generation of a ground truth flow map as described in connection with FIGS. 2 and 2A, various changes may be FIG. 3. For example, the images 201 being processed and the resulting depth maps 203 being generated can vary widely based on the contents of the scenes being imaged.

FIGS. 4A through 4C illustrate example camera rotations supported by the motion model 204 during generation of a ground truth flow map as described in connection with FIGS. 2 and 2A in accordance with this disclosure. More specifically, FIGS. 4A through 4C depict an example coordinate system having x, y, and z axes. FIGS. 4A through 4C also depict example rotational motions about these axes as α (rotation about the z axis), β (rotation about the y axis), and γ (rotation about the x axis). The motion model 204 can support global rotation (R) and translation (t) of camera perspectives in this 3D coordinate system. In other words, the motion model 204 can be used to define different camera perspectives based on different combinations of global rotation and translation values.

In some embodiments, the motion model 204 includes or is defined using camera intrinsic parameters and extrinsic parameters. In some cases, the intrinsic parameters K may be defined as follows.

$$K = [ \begin{matrix}f & 0 & cx \\ 0 & f & cy \\ 0 & 0 & 1\end{matrix} ]$$

Here, f is the camera focal distance (focal length), and cx and cy are the camera sensor's center coordinates (principal point offset) in the x-y plane (assuming the z coordinate is set to 1). Also, in some cases, the extrinsic parameters M may be defined as follows.

$$M = [ ( R \vert t ) ]$$

Further, in some cases, the translation (t) may be defined as follows.

$$t = [ \begin{matrix}tx \\ ty \\ tz\end{matrix} ]$$

Here, tx, ty, and tz are translations along the x, y, and z axes, respectively. In addition, in some cases, the rotation (R) may be defined as follows.

$$R = {R}_{z} ( γ ) {R}_{y} ( β ) {R}_{x} ( α ) = [ \begin{matrix}cos γ & - sin γ & 0 \\ sin γ & cos γ & 0 \\ 0 & 0 & 1\end{matrix} ] [ \begin{matrix}cos β & 0 & sin β \\ 0 & 1 & 0 \\ - sin β & 0 & cos β\end{matrix} ] [ \text{} \begin{matrix}1 & 0 & 0 \\ 0 & cos α & - s in α \\ 0 & sin α & cos α\end{matrix} ] = [ \begin{matrix}cos β cos γ & \begin{matrix}sin α sin β cos γ - \\ cos α sin γ\end{matrix} & \begin{matrix}cos α sin β cos γ - \\ sin α sin γ\end{matrix} \\ cos β sin γ & \begin{matrix}sin α sin β sin γ + \\ cos α cos γ\end{matrix} & \begin{matrix}cos α sin β sin γ - \\ sin α cos γ\end{matrix} \\ - sin β & sin α cos β & cos α cos β\end{matrix} ]$$

Using the above parameters for the motion model 204, pixels for a reprojected view 207 may be determined as follows.

$$z [ \begin{matrix}{x}_{2} \\ {y}_{2} \\ 1\end{matrix} ] = K [ ( R \vert t ) ] [ \begin{matrix}{X}_{1} \\ {Y}_{1} \\ {Z}_{1} \\ 1\end{matrix} ]$$

Here, K is a 3×3 intrinsic matrix, R is a 3×3 rotation matrix determined as described above, and t is a 3×1 translation vector determined as described above. Also, [X₁, Y₁, Z₁] are the 3D coordinates for the reference view, and [x₂,y₂] are the 2D coordinates for pixels within the reprojected view.

Although FIGS. 4A through 4C illustrate examples of motions supported by the motion model 204 during generation of a ground truth flow map as described in connection with FIGS. 2 and 2A, various changes may be made to FIGS. 4A through 4C. For example, reprojected views may be generated using any suitable combination of rotational and/or translational movements between camera perspectives. These reprojected views may be generated in any suitable manner based on any suitable coordinate system and associated projection calculations.

FIG. 5 illustrates example operation of a 3D to 2D reprojection function 205 used during generation of a ground truth flow map as described in connection with FIGS. 2 and 2A in accordance with this disclosure. As shown in FIG. 5, the example reference image 201 and the example depth map 203 from FIG. 3 are provided to the 3D to 2D reprojection function 205, which uses these inputs to generate a reprojected view 207. The 3D to 2D reprojection function 205 uses the camera intrinsic parameters to project the 3D coordinate system of the second view of the input image onto the imaging plane of the reference image. In this example, the camera perspective for the reprojected view 207 is shifted to the right relative to the camera perspective for the reference image 201. This can lead to the creation of artifacts along the left edge of the frame, since no image pixel data for those locations is available in the captured image 201. This can also lead to the creation of artifacts along the right edge(s) of one or more foreground objects in the captured image 201, since the foreground object(s) can occlude the background of the captured image 201.

Although FIG. 5 illustrates one example operation of a 3D to 2D reprojection function 205 used during generation of a ground truth flow map as described in connection with FIGS. 2 and 2A, various changes may be FIG. 5. For example, the images 201 and depth maps 203 being processed and the resulting reprojected views 207 being generated can vary widely based on the contents of the scenes being imaged.

FIGS. 6A through 6F illustrate example computation of a ground truth flow map 212 as described in connection with FIGS. 2 and 2A in accordance with this disclosure. In some embodiments, the ground truth flow generation function 211 may utilize the following computations when generating a ground truth flow map 212.

$$z [ \begin{matrix}{x}_{2} \\ {y}_{2} \\ 1\end{matrix} ] = K [ ( R \vert t ) ] [ \begin{matrix}{X}_{1} \\ {Y}_{1} \\ {Z}_{1} \\ 1\end{matrix} ]$$

$$Flow [ {x}_{1} , {y}_{1} , 0 ] = {x}_{2} - {x}_{1}$$

$$Flow [ {x}_{1} , {y}_{1} , 1 ] = {y}_{2} - {y}_{1}$$

As shown here, FIG. 6A illustrates a captured image 201, and FIG. 6B represents its corresponding ground truth flow map 212 as determined using these equations. FIG. 6C illustrates an image 601 of the same scene reprojected from a different perspective, meaning with motion of the camera. FIG. 6D illustrates a warped image 602, which represents the image 601 as warped to the reference (captured image 201) using the ground truth flow map 212. As can be seen here, the ground truth warp aligns the images 602 and 201 very well, except for occluded regions. This can be seen in FIGS. 6E and 6F, where FIG. 6E illustrates differences 603 between the images 201 and 601 and FIG. 6F illustrates differences 604 between the images 201 and 602. The differences shown in FIG. 6F represent occluded regions.

Although FIGS. 6A through 6F illustrate one example computation of a ground truth flow map 212 as described in connection with FIGS. 2 and 2A, various changes may be made to FIGS. 6A through 6F. For example, the ground truth flow maps 212 being generated can vary widely based on the contents of the scenes being imaged. Also, the specific camera viewpoints shown here are for illustration and explanation only.

FIGS. 7A through 7C graphically illustrate an example determination of an occlusion mask 208 and subsequent inpainting for use with a ground truth flow map 212 as described in connection with FIGS. 2 and 2A in accordance with this disclosure. As noted above, the occlusion mask 208 identifies where a reprojected view 207 may lack image content, such as due to occlusion of one object by another object within the scene. In some cases, for example, the occlusion mask 208 can identify one or more areas of one or more background objects in the captured (or “reference”) image 201 that had previously been occluded by one or more foreground objects. Thus, when the camera perspective shifts, pixel information may not be available for those regions for reprojection.

In some embodiments, the occlusion mask 208 can be determined entirely from estimated depth information and the camera motion. For example, in some cases, the pixel coordinates for the occlusion mask 208 may be determined as follows.

$$z [ \begin{matrix}{x}_{2} \\ {y}_{2} \\ 1\end{matrix} ] = K [ \begin{matrix}{X}_{2} \\ {Y}_{2} \\ {Z}_{2}\end{matrix} ] = K [ ( R \vert t ) ] [ \begin{matrix}{X}_{1} \\ {Y}_{1} \\ {Z}_{1} \\ 1\end{matrix} ]$$

where [X₂, Y₂, Z₂] are the 3D world coordinates for pixels of the captured image 201 relative to the second camera perspective. Furthermore, in some cases, the pixel values for the occlusion mask 208 may be determined as follows.

Mask=ones((w,h))
Let X₂, Y₂, Z₂ be the sets of all the x coordinates, the y coordinates, and the z coordinates respectively of the pixels of the reference image in the 3D world relative to the second camera perspective

$$for ( x , y , z ) ∈ {X}_{2} \times {Y}_{2} \times {Z}_{2}$$

$$p = K [ \begin{matrix}x \\ y \\ z\end{matrix} ]$$

$${x}^{′} = p ( 1 ) / p ( 3 )$$

$${y}^{′} = p ( 2 ) / p ( 3 )$$

$$Mask ( {x}^{′} , {y}^{′} ) = 0$$

$$end for$$

The inpainting function 209 is used to generate image data for one or more regions in which pixel information is lacking as determined by the occlusion mask 208. For example, FIG. 7A illustrates an example reprojected view 207, and FIG. 7B illustrates an example graphic representation of its corresponding occlusion mask 208. FIG. 7C illustrates a resulting inpainted reprojected view 210, which can be generated by the inpainting function 209 filling in missing image data within the reprojected view 207 (in regions of the reprojected view 207 as defined by the occlusion mask 208). The inpainting function 209 may use any suitable technique to perform image inpainting. In some embodiments, for example, the inpainting function 209 may use the techniques described in Telea, “An image inpainting technique based on the fast marching method,” Journal of Graphics Tools 9.1, 2004 (which is hereby incorporated by reference in its entirety).

Although FIGS. 7A through 7C graphically illustrate one example determination of an occlusion mask 208 and subsequent inpainting for use with a ground truth flow map 212 as described in connection with FIGS. 2 and 2A, various changes may be made to FIGS. 7A through 7C. For example, the occlusion mask 208 and inpainted reprojected view 210 being generated can vary widely based on the contents of the scenes being imaged and the camera viewpoints being used.

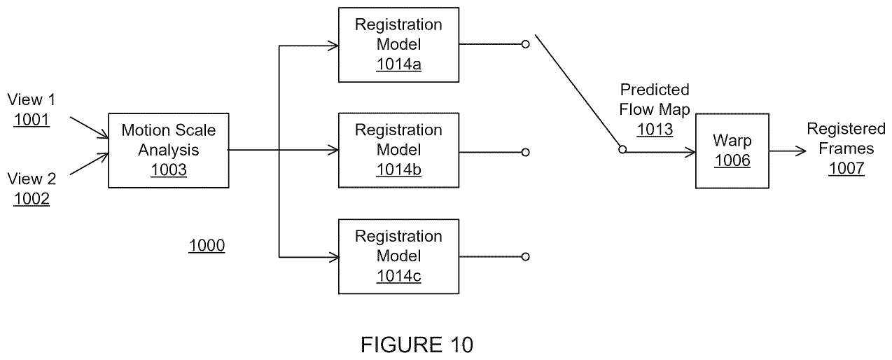

FIGS. 8 and 9 comparatively illustrate a non-AI method of image registration with use of inferences on a registration model trained on synthetic data in accordance with this disclosure. As shown in FIG. 8, an architecture 800 receives frames 801 and 802 as inputs and estimates a flow map 803 based on feature mapping of the frames 801 and 802. The estimated flow map 803 is used to estimate a locally-varying affine map 804, which is a geometric transformation that preserves lines and parallelism but not necessarily Euclidean distances and angles. The resulting locally-varying affine map 804 is used to compute a pixel-wise displacement map 805, which identifies how pixels for features within the two frames 801 and 802 are displaced from one another. The pixel-wise displacement map 805 is used by a warp function 806 to warp one or both of the frames 801 and 802, thereby producing registered frames 807.

As shown in FIG. 9, an architecture 900 performs image registration inferences using a registration model 215 trained on synthetic data. Following training of the registration model 215 as described above, two views 901 and 902 are received as inputs to the registration model 215. The registration model 215 performs inferencing based on the views 901 and 902 and produces a predicted flow map 913 for pixel/object flows within the coordinate system as camera perspective shifts from the view 901 to the view 902. The predicted flow map 913 is used by a warp function 906 to warp one or both of the views 901 and 902, thereby producing registered frames 907. Here, the registration model 215 achieves improved image registration between the images of the views 901 and 902 (relative to the image registration achieved for the registered frames 807).

Although FIGS. 8 and 9 comparatively illustrate one example of a non-AI method of image registration with use of inferences on a registration model trained on synthetic data, various changes may be made to FIGS. 8 and 9. For example, the registration model 215 may be used in any other suitable pipeline.

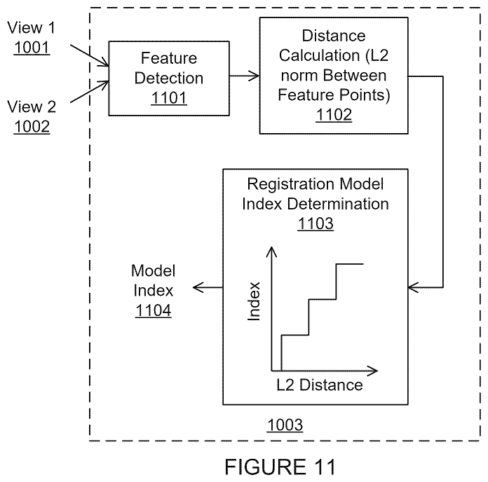

FIG. 10 illustrates an example system 1000 using multiple registration models trained on synthetic data in accordance with this disclosure. For ease of explanation, the system 1000 shown in FIG. 10 is described as being implemented using one or more components of the network configuration 100 of FIG. 1 described above, such as the electronic device 101. However, this is merely one example, and the system 1000 could be implemented using any other suitable device(s) and in any other suitable system(s), such as when the system 1000 is implemented using one or more servers 106.

As shown in FIG. 10, two views 1001 and 1002 are received as inputs to the system 1000. A motion scale analysis function 1003 processes the views 1001 and 1002 in order to determine an amount of shift in camera perspective between the views 1001 and 1002. For example, the motion scale analysis function 1003 may identify the amount of translation and/or the amount of rotation needed to shift the camera perspective from the view 1001 to the view 1002 (or vice versa).

The system 1000 also includes multiple image registration models 1014a-1014c, each of which may be trained using synthetic data with a different range of camera motion for shifted camera perspectives. For example, the image registration model 1014a may be trained using synthetic data having smaller levels of camera motion, the image registration model 1014b may be trained using synthetic data having medium levels of camera motion, and the image registration model 1014c may be trained using synthetic data having larger levels of camera motion. That is, the training of the registration model 1014a may use synthetic data with relatively small shifts in camera perspective, while the training of the registration model 1014c may use synthetic data with relatively large shifts in camera perspective.

As a result, the inferences generated by the image registration models 1014a-1014c may be better suited for their respective datasets, which include different extents or scales of motion. Thus, during use of the system 1000, the extent of motion as determined by the motion scale analysis function 1003 can be used to select which of the image registration models 1014a-1014c is used to perform registration of images. In other words, the extent of motion as determined by the motion scale analysis function 1003 can be used to control which of the image registration model 1014a-1014c is used to process and align images. In the example shown in FIG. 10, if small motion is detected between the two views 1001 and 1002, the image registration model 1014a would be selected. In cases of medium motion, the image registration model 1014b would be selected. Finally, in cases of large motion, the image registration model 1014c would be selected.

Although FIG. 10 illustrates one example of a system 1000 using multiple registration models 1014a-1014c trained on synthetic data, various changes may be made to FIG. 10. For example, various components and functions in FIG. 10 may be combined, further subdivided, replicated, rearranged, or omitted according to particular needs. Also, one or more additional components and functions may be included in FIG. 10 if needed or desired. As a particular example, while the motion scale analysis function 1003 has been described in the context of using three image registration models 1014a-1014c here, this is not necessarily required. For instance, two or more than three image registration models may be used. In addition, all of the image registration models may be used to process the same inputs, and the outputs from one or more of the image registration models may be selected. The predicted flow map 1013 from one of the image registration models 1014a, 1014b, or 1014c is provided to a warp function 1006 to produce registered frames 1007 in the manner described above.

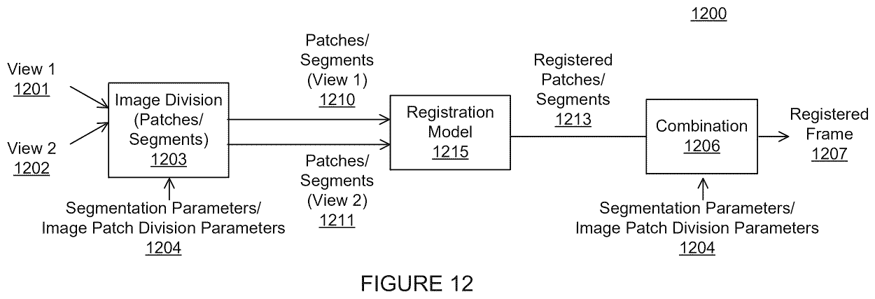

FIG. 11 illustrates an example motion scale analysis function 1003 as described in connection with FIG. 10 in accordance with this disclosure. As shown in FIG. 11, a feature detection function 1101 processes the views 1001 and 1002 in order to identify various features of the contents of the views 1001 and 1002. The feature detection function 1101 may identify any suitable features associated with the views 1001 and 1002. For example, corner detection and/or scale-invariant feature transform (SIFT) may be employed by the feature detection function 1101. A distance calculation function 1102 processes the identified features in order to calculate one or more distances between the identified features. The distance calculation function 1102 may identify any suitable distance(s) between the identified features, such as by determining the L2 norm of Euclidean distance between the identified features.

The mean distance of all feature points is provided to a registration model index determination function 1103, which can generate a model index 1104. The registration model index determination function 1103 uses the identified distance to select one of multiple image registration models (such as one of the registration models 1014a-1014c) based on the distance. The selected image registration model is identified by the value of the model index 1104.

Although FIG. 11 illustrates one example of the motion scale analysis function 1003 as described in connection with FIG. 10, various changes may be made to FIG. 11. For example, various components and functions in FIG. 11 may be combined, further subdivided, replicated, rearranged, or omitted according to particular needs. Also, one or more additional components and functions may be included in FIG. 11 if needed or desired.

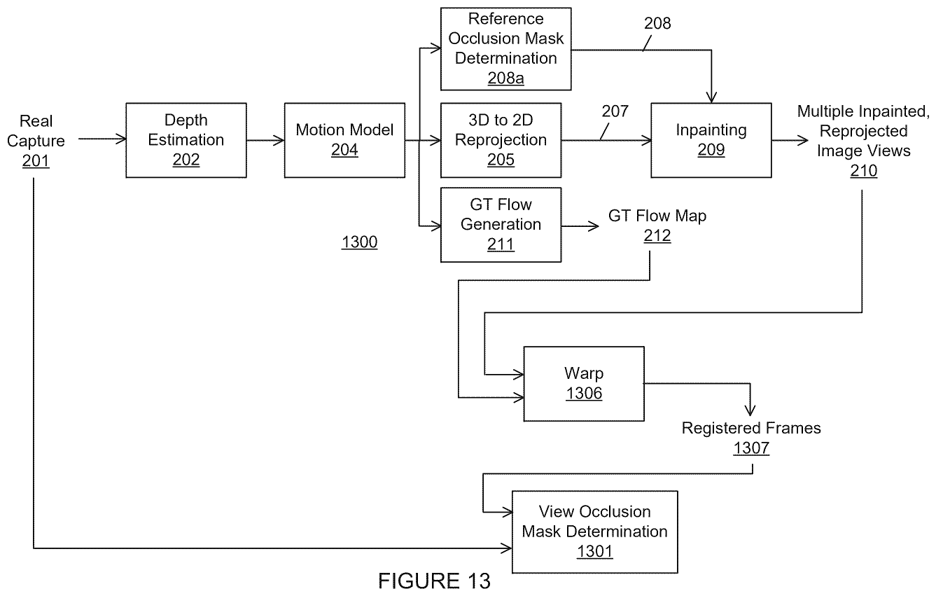

FIG. 12 illustrates an example system 1200 utilizing image patch division or segmentation in conjunction with a registration model trained on synthetic data in accordance with this disclosure. For ease of explanation, the system 1200 shown in FIG. 12 is described as being implemented using one or more components of the network configuration 100 of FIG. 1 described above, such as the electronic device 101. However, this is merely one example, and the system 1200 could be implemented using any other suitable device(s) and in any other suitable system(s), such as when the system 1200 is implemented using one or more servers 106.

As shown in FIG. 12, two views 1201 and 1202 are received as inputs to the system 1200. An image division function 1203 processes each view 1201 and 1202 and divides each view 1201 and 1202 into patches or segments 1210 or 1211. In some cases, the image division function 1203 can divide views based on one or more segmentation parameters and/or image patch division parameters 1204, such as one or more parameters defining the number of patches/segments, the size of the patches/segments, or both. The patches or segments 1210 for the view 1201 and the patches or segments 1211 for the view 1202 are provided to a registration model 1215, which can be trained using synthetic data as described above. The registration model 1215 performs inferencing to register the patches or segments 1210 and 1211 in order to generate registered patches or segments 1213. In some cases, for example, the registration model 1215 may modify the patches or segments 1211 to be aligned with the patches or segments 1210 (or vice versa).

The registered patches or segments 1213 for the views 1201 and 1202 are provided to a combination function 1206, which can combine the registered patches or segments 1213. In some cases, the combination function 1206 may combine the registered patches or segments 1213 based on the one or more segmentation parameters and/or image patch division parameters 1204. This results in the generation of registered frames 1207.

Although FIG. 12 illustrates one example of a system 1200 utilizing image patch division or segmentation in conjunction with a registration model trained on synthetic data, various changes may be made to FIG. 12. For example, various components and functions in FIG. 12 may be combined, further subdivided, replicated, rearranged, or omitted according to particular needs. Also, one or more additional components and functions may be included in FIG. 12 if needed or desired.

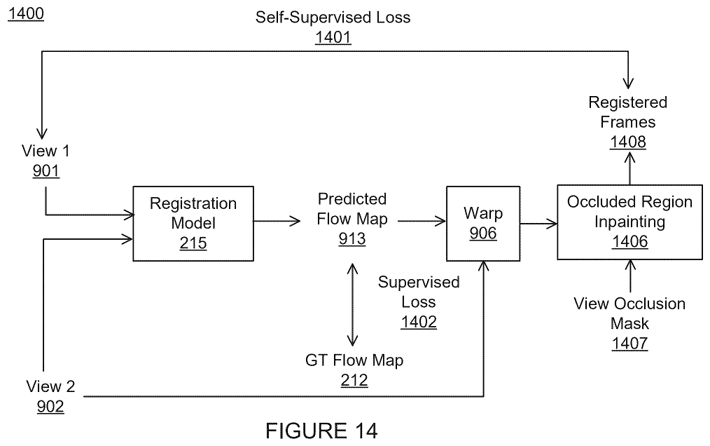

FIG. 13 illustrates an example process 1300 for generation of synthetic data with additional view occlusion mask determination for training a registration model in accordance with this disclosure. For ease of explanation, the process 1300 shown in FIG. 13 is described as being implemented using one or more components of the network configuration 100 of FIG. 1 described above, such as one or more servers 106. However, this is merely one example, and the process 1300 could be implemented using any other suitable device(s) and in any other suitable system(s), such as when the process 1300 are performed using an electronic device 101. Note that parts of the process 1300 are similar to a portion of the process 200 described above in connection with FIGS. 2 and 2A. As a result, the descriptions of elements from FIGS. 2 and 2A are not repeated here.

As shown in FIG. 13, a reference occlusion mask determination function 208a is used to generate an occlusion mask 208 for a reference image. The reference occlusion mask 208 in FIGS. 2 and 2A relates to or represents occluded regions in the reference image that will not have pixel information for use during reprojection. Here, the reference occlusion mask determination function 208a can generate the occlusion mask 208 for the reference image. As shown in FIG. 2 or 2A, the reference occlusion mask determination function 208a may be used in the process 200 to generate the reference occlusion mask 208 for the reference image.

It is also possible for a “view” occlusion mask to be determined, where the view occlusion mask identifies one or more occluded regions in a synthetic view images that will not have pixel information after registration and/or warping. Accordingly, in the process 1300, one or more inpainted reprojected image views 210 and the corresponding ground truth flow map(s) 212 are provided to a warp function 1306. The warp function 1306 warps the inpainted reprojected image view(s) 210 based on the ground truth flow map(s) 212 to produce registered frames 1307. The warp function 1306 here may be analogous to the warp function 906 in FIG. 9, except that a ground truth flow map 212 is used in FIG. 12 instead of a predicted flow map 913. The registered frames 1307 thus may be analogous to the registered frames 907 in FIG. 9.

The registered frames 1307 and the captured image 201 are provided to a view occlusion mask determination function 1301. The view occlusion mask determination function 1301 uses a warped version of an inpainted reprojected image view 210 as well as the captured image 201. Both the reference occlusion mask determination function 208a and the view occlusion mask determination function 1301 may therefore generally operate in the same or similar manner as described above in connection with FIGS. 7A through 7C. In some cases, the view occlusion mask can be determined as follows.

$${Mask}_{view} ( x , y ) = \{ \begin{matrix}1 & if \vert {I}_{1} ( x , y ) - {I}_{2} ( x , y ) \vert > threshold \\ 0 & otherwise\end{matrix}$$

Here, I₁ is the captured image 201, and I₂ is the warped/registered frame(s) 1307. Since the ground truth optical flow map is used to warp the image, the absolute difference between the registered frames 1307 and the captured image 201 will be very close to zero at all pixels except regions that were occluded in the reprojected image views 210 before warping. A small threshold can be used to determine the pixel locations for the occlusion mask.

Although FIG. 13 illustrates one example of a process 1300 for generation of synthetic data for training a registration model, various changes may be made to FIG. 13. For example, various components and functions in FIG. 13 may be combined, further subdivided, replicated, rearranged, or omitted according to particular needs. Also, one or more additional components and functions may be included in FIG. 13 if needed or desired.

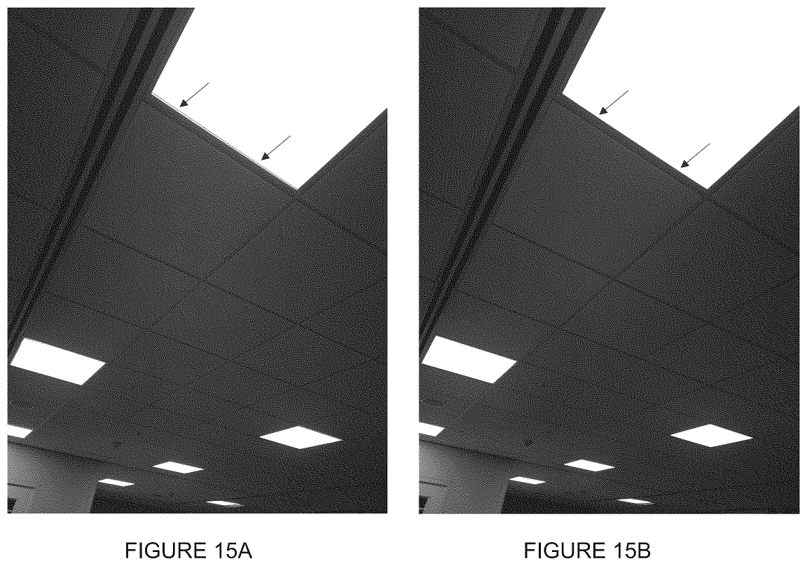

FIG. 14 illustrates an example process 1400 for training an image registration model on synthetic data in accordance with this disclosure. For ease of explanation, the process 1400 shown in FIG. 14 is described as being implemented using one or more components of the network configuration 100 of FIG. 1 described above, such as one or more servers 106. However, this is merely one example, and the process 1400 could be implemented using any other suitable device(s) and in any other suitable system(s), such as when the process 1400 are performed using an electronic device 101. Note that parts of the process 1400 are similar to a portion of the process performed by the architecture 900 described above in connection with FIG. 9. As a result, the descriptions of elements from FIG. 9 are not repeated here.

As shown in FIG. 14, the process 1400 involves training the registration model 215 using two views 901 and 902. The views 901 and 902 are provided to the registration model 215 being trained, which generates a predicted flow map 913. The predicted flow map 913 is provided to the warp function 906. Instead of using the warp function 906 to directly generate registered frames here, the warped frames are provided to an occluded region inpainting function 1406, which performs inpainting based on one or more view occlusion masks 1407. The one or more view occlusion masks 1407 may be generated by the view occlusion mask determination function 1301 as described above. The inpainting here can help to fill in any missing image data, and registered frames 1408 can be generated with little or no missing image data.

In this example, the registration model 215 is trained using both a self-supervised loss function 1401 and a supervised loss function 1402. The self-supervised loss function 1401 is used to determine a loss based on the view 901 and one or more of the registered frames 1408. The supervised loss function 1402 is used to determine a loss based on the predicted flow map 913 and a corresponding ground truth flow map 212. Furthermore, the self-supervised loss function can also be adjusted to discount the differences between pixels in the occluded regions as provided by the view occlusion mask(s) 1407. The total loss of the registration model 215 can be based on a combination of the two losses, such as a sum or weighted sum of the two losses.

Although FIG. 14 illustrates one example of a process 1400 for training an image registration model on synthetic data, various changes may be made to FIG. 14. For example, various components and functions in FIG. 14 may be combined, further subdivided, replicated, rearranged, or omitted according to particular needs. Also, one or more additional components and functions may be included in FIG. 14 if needed or desired. In addition, other or additional losses or combinations of losses may be used here to train the registration model 215.

It should be noted that the functions shown in or described with respect to FIGS. 2 through 14 can be implemented in an electronic device 101, server 106, or other device in any suitable manner. For example, in some embodiments, at least some of the functions shown in or described with respect to FIGS. 2 through 14 can be implemented or supported using one or more software applications or other software instructions that are executed by the processor 120 of the electronic device 101, server 106, or other device. In other embodiments, at least some of the functions shown in or described with respect to FIGS. 2 through 14 can be implemented or supported using dedicated hardware components. In general, the functions shown in or described with respect to FIGS. 2 through 14 can be performed using any suitable hardware or any suitable combination of hardware and software/firmware instructions. Also, the functions shown in or described with respect to FIGS. 2 through 14 can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. An electronic device comprising:
at least one memory configured to store a motion model for determining three-dimensional (3D) coordinates of pixels within a reference image based on estimated depths of the pixels within the reference image; and
at least one processing device configured to:
generate a ground truth optical flow map for displacement of the pixels within the reference image based on the motion model;
perform 3D to two-dimensional (2D) reprojection of the pixels within the reference image based on the motion model to generate a reprojected image view corresponding to a shifted camera perspective;
generate an occlusion mask for the reference image, the occlusion mask corresponding to occluded pixels within the reprojected image view; and
perform occlusion region inpainting of the occluded pixels to generate an inpainted reprojected image view.

2. The electronic device of claim 1, wherein:
the occlusion mask for the reference image comprises a reference occlusion mask;
the inpainted reprojected image view comprises a first of at least one inpainted reprojected image view; and
the at least one processing device is further configured to:
warp the at least one inpainted reprojected image view based on the ground truth optical flow map to generate one or more registered frames; and
generate a ground truth view occlusion mask using the reference image and the one or more registered frames.

3. The electronic device of claim 1, wherein:
the at least one processing device is further configured to train an image registration model to generate a predicted flow map based on the reference image and the inpainted reprojected image view; and
the at least one processing device is configured to apply a supervised loss function between the predicted flow map and the ground truth optical flow map.

4. The electronic device of claim 3, wherein the at least one processing device is further configured to:
warp the inpainted reprojected image view to the reference image based on the predicted flow map to generate a predicted image registration; and
remove or inpaint one or more occluded regions within the predicted image registration based on a ground truth view occlusion mask to generate a registered frame for the predicted image registration.

5. The electronic device of claim 4, wherein the at least one processing device is configured to apply a self-supervised loss function between the reference image and the registered frame for the predicted image registration during the training of the image registration model.

6. The electronic device of claim 1, wherein the at least one processing device is configured to determine the ground truth optical flow map from:
$$Flow [ {x}_{1} , {y}_{1 , 0} ] = {x}_{2} - {x}_{1}$$
$$Flow [ {x}_{1} , {y}_{1 , 1} ] = {y}_{2} - {y}_{1}$$
where:
x₁,y₁ represent pixel coordinates in the reference image; and
x₂,y₂ represent pixel coordinates at counterpart locations in the inpainted reprojected image view.

7. The electronic device of claim 1, wherein:
the occlusion mask is based on the reference image and the reprojected image view; and
the occluded pixels in the reprojected image view correspond to one or more portions of a first object in the reference image that were occluded by a second object closer than the first object based on a depth map corresponding to the estimated depths of the pixels within the reference image.

8. A method comprising:
generating a ground truth optical flow map for displacement of pixels within a reference image based on a motion model, wherein the motion model determines three-dimensional (3D) coordinates of pixels within the reference image based on estimated depths of the pixels within the reference image;
performing 3D to two-dimensional (2D) reprojection of the pixels within the reference image based on the motion model to generate a reprojected image view corresponding to a shifted camera perspective;
generating an occlusion mask for the reference image, the occlusion mask corresponding to occluded pixels within the reprojected image view; and
performing occlusion region inpainting of the occluded pixels to generate an inpainted reprojected image view.

9. The method of claim 8, wherein:
the occlusion mask for the reference image comprises a reference occlusion mask;
the inpainted reprojected image view comprises a first of at least one inpainted reprojected image view; and
the method further comprises:
warping the at least one inpainted reprojected image view based on the ground truth optical flow map to generate one or more registered frames; and
generating a ground truth view occlusion mask using the reference image and the one or more registered frames.

10. The method of claim 8, further comprising:
training an image registration model to generate a predicted flow map based on the reference image and the inpainted reprojected image view; and
applying a supervised loss function between the predicted flow map and the ground truth optical flow map.

11. The method of claim 10, further comprising:
warping the inpainted reprojected image view to the reference image based on the predicted flow map to generate a predicted image registration; and
removing or inpainting one or more occluded regions within the predicted image registration based on a ground truth view occlusion mask to generate a registered frame for the predicted image registration.

12. The method of claim 11, further comprising:
applying a self-supervised loss function between the reference image and the registered frame for the predicted image registration during the training of the image registration model.

13. The method of claim 8, wherein the ground truth optical flow map is determined from:
$$Flow [ {x}_{1} , {y}_{1 , 0} ] = {x}_{2} - {x}_{1}$$
$$Flow [ {x}_{1} , {y}_{1 , 1} ] = {y}_{2} - {y}_{1}$$
where:
x₁,y₁ represent pixel coordinates in the reference image; and
x₂,y₂ represent pixel coordinates at counterpart locations in the inpainted reprojected image view.

14. The method of claim 8, wherein:
the occlusion mask is based on the reference image and the reprojected image view; and
the occluded pixels in the reprojected image view correspond to one or more portions of a first object in the reference image that were occluded by a second object closer than the first object based on a depth map corresponding to the estimated depths of the pixels within the reference image.

15. An electronic device comprising:
at least one memory configured to store:
a first image registration model and a second image registration model each trained using synthetic data; and
first and second images, the first image corresponding to a scene from a first camera perspective, the second image corresponding to the scene from a second camera perspective; and
at least one processing device configured to:
analyze motion between the first camera perspective and the second camera perspective; and
based on the analyzed motion, select one of the first image registration model and the second image registration model to perform registration of the first image and the second image.

16. The electronic device of claim 15, wherein the at least one processing device is further configured to warp the second image to the first image based on inferences by the selected one of the first image registration model and the second image registration model to generate a registered frame.

17. The electronic device of claim 15, wherein the at least one processing device is further configured to:
detect features of the first image and corresponding features of the second image;
determine a distance between the features of the first image and the features of the second image; and
identify an index for the selected one of the first image registration model and the second image registration model based on the determined distance.

18. The electronic device of claim 15, wherein the at least one processing device is further configured to:
logically divide the first image and the second image into segments based on one or more segmentation parameters corresponding to the analyzed motion;
employ the selected one of the first image registration model and the second image registration model to warp each segment from the first image with a corresponding segment from the second image; and
combine the warped segments according to the one or more segmentation parameters to generate a registered frame.

19. The electronic device of claim 18, wherein the at least one processing device is configured to warp each segment from the first image with the corresponding segment from the second image based on inferences by the selected one of the first image registration model and the second image registration model.

20. The electronic device of claim 15, wherein the at least one processing device is further configured to:
logically divide the first image and the second image into image patches based on one or more image patch division parameters corresponding to the analyzed motion;
employ the selected one of the first image registration model and the second image registration model to warp each image patch from the first image with a corresponding image patch from the second image; and
combine the warped image patches according to the one or more image patch division parameters to generate a registered frame.
